(19) United States
(12) Patent Application Publication
(10) Pub. No.: US 2010/0163183 A1
(43) Pub. Date: Jul. 1, 2010

(54) MOUNTING TABLE STRUCTURE AND HEAT TREATMENT APPARATUS

(75) Inventors: Sumi TANAKA, Nirasaki-shi (JP); Hiroo KAWASAKI, Nirasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, Tokyo (JP)

(21) Appl. No.: 12/647,985

(22) Filed: Dec. 28, 2009

Related U.S. Application Data
(63) Continuation of application No. PCT/JP08/61568, filed on Jun. 25, 2008.

(30) Foreign Application Priority Data
Jun. 28, 2007 (JP) 2007-170657

(51) Int. Cl. C23F 1/08; B05C 11/00

(52) U.S. Cl. 156/345.27; 118/712

(57) ABSTRACT

A mounting table structure includes a mounting table provided with a heating unit having heaters respectively arranged in concentrically divided heating zones and on which an object to be heat-treated is placed, a temperature measurement units respectively arranged in the heating zones, and a hollow column for supporting the mounting table in an upstanding state. The diameter of the column is gradually expanded from its bottom to its top, and the upper end of the column is bonded to the bottom surface of the mounting table. A measurement unit main body of each temperature measurement unit is inserted into the hollow column and an insertion passageway provided at a sidewall of the column.

This application is a Continuation Application of PCT International Application No. PCT/JP2008/061568 filed on Jun. 25, 2008, which designated the United States.

### FIELD OF THE INVENTION

The present invention relates to a heat treatment apparatus for treating a target object such as a semiconductor wafer and a mounting table structure used in the heat treatment apparatus.

### BACKGROUND OF THE INVENTION

Generally, in manufacturing semiconductor integrated circuits, various single-wafer processes such as a film forming process, an etching process, a heat treatment, a modification process and a crystallization process are repeatedly carried out on a target object such as a semiconductor wafer to form desired integrated circuits. In such processes, processing gases required for the corresponding processes, e.g., a film forming gas for the film forming process, an ozone gas or the like for the modification process, and an O₂ gas, a nonreactive gas such as N₂ gas or the like for the crystallization process, are respectively introduced into a processing chamber.

For instance, in a single-wafer heat treatment apparatus for heat-treating semiconductor wafers one by one, a mounting table including therein, e.g., a resistance heater is installed in a vacuum evacuable processing chamber. A semiconductor wafer is mounted on a top surface of the mounting table. In this state, predetermined processing gases are introduced into the processing chamber and various heat treatments are performed on the semiconductor wafers under given process conditions.

Meanwhile, generally, the mounting table is installed in the processing chamber while the surface thereof is exposed. Accordingly, some heavy metals or the like contained in a material of the mounting table, e.g., ceramic such as AlN or metal, are diffused into the processing chamber due to heat, thereby causing contamination such as metal contamination. As for the contamination such as metal contamination, strict measures are required particularly when an organic metal material is used as a source gas for film formation as in a recent case.

Typically, a heater provided in the mounting table individually controls temperatures of a plurality of concentrically divided zones to realize an optimal temperature distribution for processing of the wafer. However, when powers inputted to the respective zones are largely different from each other, the material of the mounting table has different thermal expansion coefficients in the respective zones, and it may lead to damage to the mounting table. Further, when the mounting table is made of AlN or the like, an insulating resistance of the AlN material remarkably decreases to cause leakage current. Accordingly, conventionally, it is impossible to increase the process temperature to about 650° C. or more.

Further, when a film forming process for depositing a thin film on the surface of the wafer is carried out as a heat treatment, the thin film is formed, as an unnecessary film, on the surface of the mounting table or the inner wall surface of the processing chamber, in addition to the surface of the wafer that is intended to be covered with the thin film. In this case, when the unnecessary film is peeled off, it generates particles resulting in a reduction in production yield. Thus, a cleaning process is performed regularly or irregularly to remove the unnecessary film by flowing an etching gas into the processing chamber or by immersing the structures of the processing chamber in an etching solution such as acetic acid.

For contamination prevention and reduction of cleaning processes, there have been proposed various solutions as follows. That is, a mounting table may be configured to have a heater covered with a quartz casing as disclosed in Japanese Patent Laid-open Publication No. 1988-278322 (Patent Document 1), and a heater may be provided in a sealed case made of quartz and a resultant structure may be used as a mounting table as disclosed in Japanese Patent Laid-open Publication No. 1995-078766 (Patent Document 2). Further, a heater itself may be used as a mounting table as disclosed in Japanese Patent Laid-open Publications Nos. 1991-220718, 1994-260430 and 2004-307939 (Patent Documents 3 to 5). Furthermore, both a mounting table and a column may be formed of quartz glass as disclosed in Japanese Patent Laid-open Publication No. 2004-356624 (Patent Document 6).

However, as described above, a region of the mounting table is concentrically divided into a plurality of zones and the temperatures of the respective zones are individually controlled in order to maintain higher in-plane temperature uniformity of the wafer. In this case, prior to an actual heat treatment of the wafer, thermocouples for measurement of temperatures are respectively provided in a central zone and a peripheral zone, and a ratio of powers inputted to the central and peripheral zones is obtained in advance to realize uniformity in the temperatures of the central and peripheral zones. Then, in the actual heat treatment of the wafer, a thermocouple is provided only in the central zone and a power inputted to the peripheral zone is determined based on the temperature detected by the thermocouple and the obtained power ratio, thereby performing temperature control.

However, when heat treatments are repeatedly performed in the processing chamber, the emissivity toward the wafer in the processing chamber is varied as time goes by. Particularly, in a film forming process, an unnecessary thin film is gradually deposited on the surfaces of constituent parts in the processing chamber and, thus, the emissivity toward the wafer is largely changed. As a result, the in-plane temperature uniformity of the wafer mounted on the mounting table is getting degraded.

In this case, as described above, the cleaning process is performed regularly or irregularly to remove the thin film. However, it is impossible to prevent the emissivity toward the wafer from being gradually varied only by the cleaning process.

Therefore, in order to solve the above-mentioned problem, thermocouples are provided in both the central and peripheral zones such that thermocouples are provided in all temperature control zones, and the temperatures of the respective zones are individually controlled based on detection values of the thermocouples provided in the respective zones. However, in this case, a conductive rod of the thermocouple provided in the central zone can be inserted in a cylindrical column connected to the center of the mounting table, whereas a conductive rod of the thermocouple provided in the peripheral zone is difficult to be inserted into the cylindrical column. Further, when the conductive rod is arranged outside the column, the arrangement operation is complicated and metal contamination may occur, which is not practical.

### SUMMARY OF THE INVENTION

The present invention has been devised in order to solve the problems described above. It is an object of the present invention to provide a mounting table structure and a heat treatment apparatus capable of maintaining higher in-plane temperature uniformity of a target object and improving reproducibility of the heat treatment by providing temperature measurement units in heating zones, respectively, without complicating a structure thereof.

In accordance with a first aspect of the present invention, there is provided a mounting table structure comprising: a mounting table on which an object to be heat-treated is mounted, the mounting table including a heating unit having heaters respectively disposed in concentric heating zones; temperature measurement units respectively disposed in the heating zones; and a hollow column for supporting the mounting table in an upstanding state, wherein a diameter of the column gradually increases from its bottom to its top, an upper end of the column is bonded to a bottom surface of the mounting table, and a measurement unit main body of each of the temperature measurement units is inserted into an insertion passageway provided inside the hollow column or at a sidewall of the column.

In accordance with the mounting table structure, the diameter of the column gradually increases from the bottom to the top, and the measurement unit main body of the temperature measurement unit of the peripheral zone is inserted into the insertion passageway provided at the sidewall of the column to pass therethrough. Accordingly, it is possible to provide respective temperature measurement units corresponding to a plurality of heating zones without a complicated structure. Therefore, it is possible to maintain higher in-plane temperature uniformity of an object to be treated, and to improve reproducibility of the heat treatment.

The measurement unit main body may be formed in a bendable rod shape.

Further, the temperature measurement units may be formed of thermocouples, respectively.

Further, the mounting table and the column may be formed of the same constituent material. Preferably, the constituent material is one selected from the group consisting of metal, quartz and ceramic.

Further, the column may be formed in a shape of horn aperture expanding from its bottom to its top. In this case, preferably, a minimum value of a radius of curvature of an outer frame of the column in its cross sectional view is determined based on at least stiffness of the measurement unit main body. The minimum value of the radius of curvature may be 20 mm.

Further, the column may be formed in a tapered shape expanding from its bottom to its top.

Further, the measurement unit main body can be inserted into the column from its bottom and detached therefrom.

In accordance with a second aspect of the present invention, there is provided a heat treatment apparatus comprising: a vacuum evacuable processing chamber; the mounting table structure having any one of the features described above; a gas supply unit for supplying a gas into the processing chamber; and a temperature controller for controlling a temperature of the mounting table of the mounting table structure.

### BRIEF DESCRIPTION OF THE DRAWINGS

The objects and features of the present invention will become apparent from the following description of embodiments, given in conjunction with the accompanying drawings, in which:

FIG. 1 is a longitudinal cross sectional view of a heat treatment apparatus in accordance with an embodiment of the present invention;

FIG. 2 is an enlarged longitudinal cross sectional view showing a mounting table structure of FIG. 1;

FIG. 3 illustrates a plan view of a mounting table main body in which resistance heaters are arranged;

FIG. 4 is a cross sectional view of a column, which is taken along line A-A of FIG. 2;

FIGS. 5A to 5C illustrate a procedure for forming an insertion passageway at a sidewall of the column;

FIG. 6 illustrates a state when the column is fitted on a mounting table; and

FIG. 7 is a longitudinal cross sectional view of a modification example of the mounting table structure.

### DETAILED DESCRIPTION OF THE EMBODIMENTS

Hereinafter, a mounting table structure and a heat treatment apparatus in accordance with embodiments of the present invention will be described with reference to the accompanying drawings.

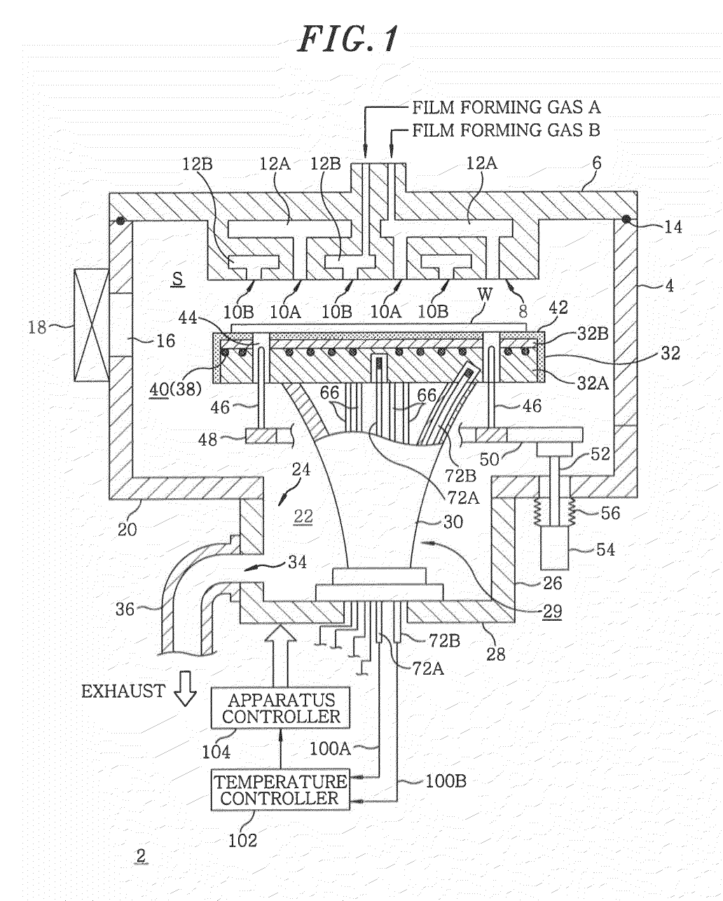

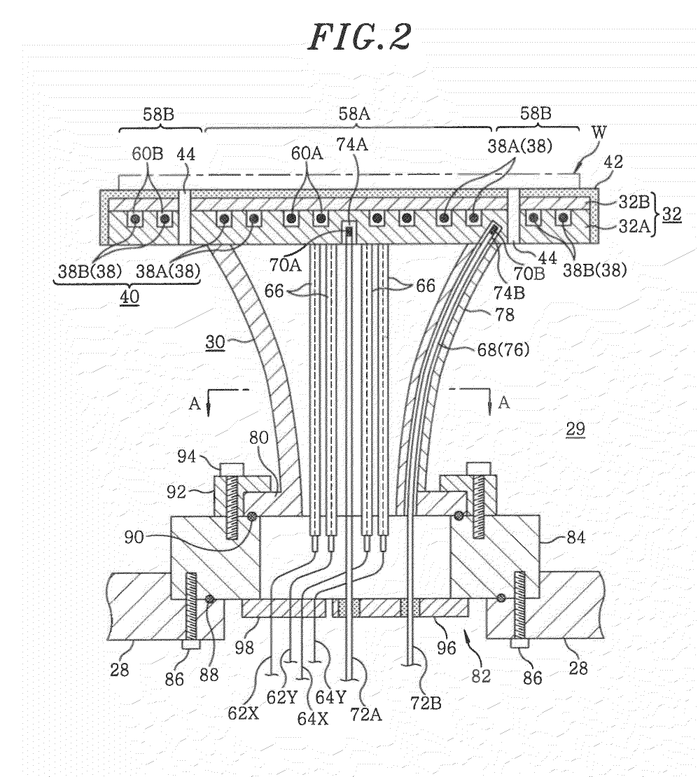

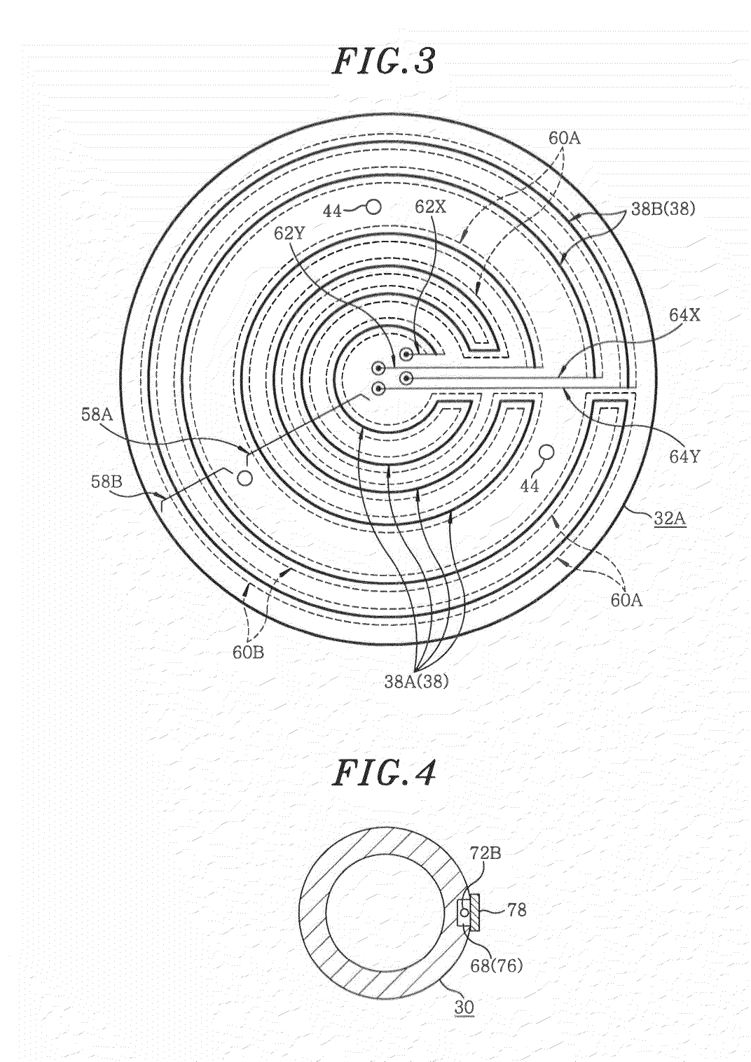

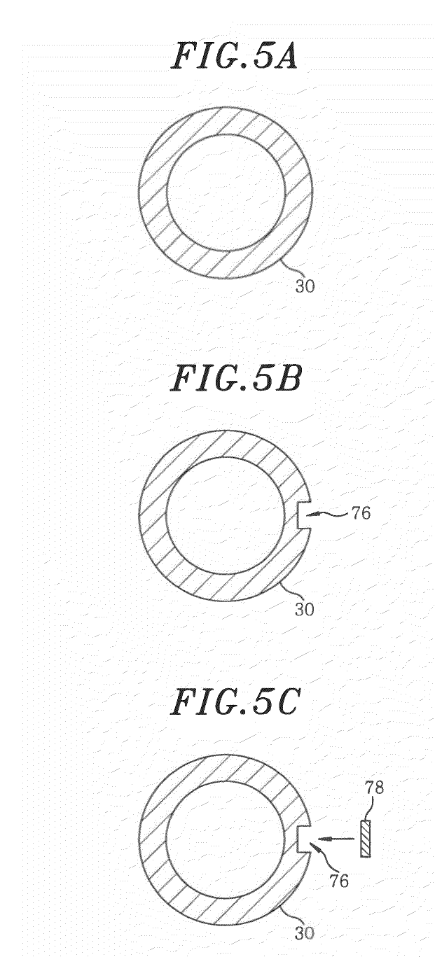

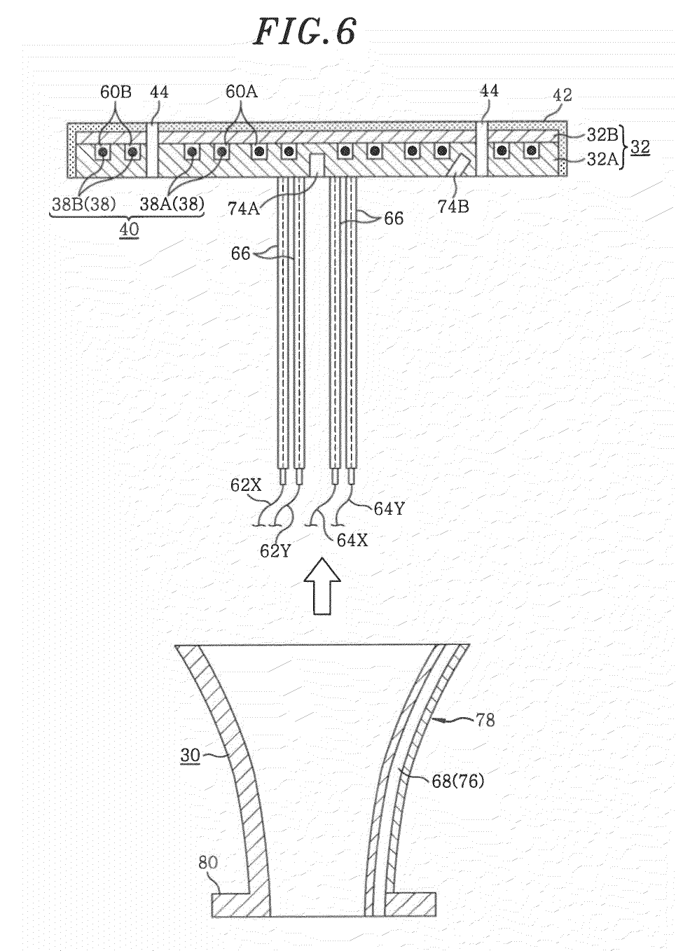

FIG. 1 is a longitudinal cross sectional view of a heat treatment apparatus in accordance with an embodiment of the present invention. In this embodiment, a film forming apparatus is described as an example of the heat treatment apparatus. FIG. 2 is an enlarged longitudinal cross sectional view showing a mounting table structure of FIG. 1. FIG. 3 illustrates a plan view of a mounting table main body in which resistance heaters are arranged. FIG. 4 is a cross sectional view of a column, which is taken along line A-A of FIG. 2. FIGS. 5A to 5C illustrate a procedure for forming an insertion passageway at a sidewall of the column. FIG. 6 illustrates a state when the column is fitted on a mounting table.

As shown in FIG. 1, a heat treatment apparatus 2 includes a processing chamber 4 made of an aluminum alloy and having an approximately cylindrical inner space. A shower head 6 serving as a gas supply unit is provided at a ceiling portion of the processing chamber 4 to introduce a desired processing gas, e.g., a film forming gas. A gas injection surface 8 that is a bottom surface of the shower head 6 has a plurality of gas injection holes 10A and 10B through which the processing gas is injected to a processing space S.

The shower head 6 includes two hollow spaces, i.e., gas diffusion spaces 12A and 12B. The processing gas is diffused in a horizontal direction in the gas diffusion spaces 12A and 12B and, then, is injected into the processing space S through the gas injection holes 10A and 10B communicating with the gas diffusion spaces 12A and 12B, respectively. The gas injection holes 10A and 10B are aligned in a matrix.

The shower head 6 may be made of, e.g., nickel, a nickel alloy such as hastelloy (registered trademark), aluminum or an aluminum alloy. The shower head 16 may have a single gas diffusion space. A gas injection nozzle may be provided instead of the shower head 6 or in addition to the shower head 6. A seal member 14 such as an O ring is interposed between the shower head 6 and an upper opening of the processing chamber 4 and, thus, the processing chamber 4 is airtightly sealed.

At the sidewall of the processing chamber 4, there is provided a gate 16 through which a semiconductor wafer W serving as an object to be treated is loaded into and unloaded from the processing chamber 4. The gate 16 is provided with a gate valve 18 configured to hermetically seal the gate 16.

A gas exhaust space 22 is formed at a bottom portion of the processing chamber 4. Specifically, a large opening 24 is formed in the center of the bottom portion 20 and is connected to a cylindrical partition wall 26 extending downward and having a bottom portion 28. An inner space of the cylindrical partition wall 26 forms the gas exhaust space 22. A mounting table structure 29, which is a feature of the present invention, is provided to stand upright at the bottom portion 28 of the cylindrical partition wall 26. The mounting table structure 29 mainly includes a hollow column 30 made of quartz glass and having a diameter gradually increasing from its lower end to its upper end, and a mounting table 32 joined and fixed to an upper end of the column 30. The mounting table structure 29 will be described in detail later.

A diameter of the opening 24 at an inlet side of the gas exhaust space 22 is smaller than that of the mounting table 32. Thus, the processing gas flowing down along a peripheral portion of the mounting table 32 turns to a bottom side of the mounting table 32 and is introduced into the opening 24. A gas exhaust port 34 communicating with the gas exhaust space 22 is formed at a lower portion of a sidewall of the cylindrical partition wall 26. The gas exhaust port 34 is connected to a gas exhaust pipe 36 provided with a vacuum pump (not shown). Accordingly, an inner space of the processing chamber 4 and the gas exhaust space 22 can be vacuum evacuated.

The gas exhaust pipe 36 is provided with a pressure control valve (not shown) whose opening degree can be controlled. The inner pressure of the processing chamber 4 can be maintained at a predetermined value or can be quickly changed to a desired value by automatically controlling the opening degree of the pressure control valve.

Further, the mounting table 32 includes a heating unit having heaters 38 embedded therein in a predetermined pattern. A thin disc-shaped top covering member 42 made of, e.g., SiC is detachably mounted on a top surface of the mounting table 32. A semiconductor wafer W serving as an object to be treated can be mounted on the top covering member 42.

A plurality of, e.g., three, pin insertion holes 44 (only two of the holes are shown in FIG. 1) are formed through the mounting table 32 in a vertical direction. Upthrust pins 46 are inserted into the respective pin insertion holes 44 with a margin to move up and down therethrough. Circular arc-shaped upthrust rings 48 made of ceramic, e.g., alumina, are disposed at bottom ends of the upthrust pins 46. The upthrust pins 46 are supported by (placed on) the upthrust rings 48 without fixation. An arm part 50 extending from the upthrust rings 48 is connected to an up/down rod 52 passing through the bottom portion 20 of the processing chamber 4, and the up/down rod 52 is lifted up and down by an actuator 54. Accordingly, when the wafer W is transferred, the upthrust pins 46 can be protruded upward from and retracted into the pin insertion holes 44. An extensible and contractible bellows 56 is provided between the actuator 54 and a part of the bottom portion 20 of the processing chamber 4 through which the up/down rod 52 of the actuator 54 passes. Thus, the up/down rod 52 can move up and down while maintaining airtightness of the processing chamber 4.

Next, the mounting table structure 29 in accordance with the embodiment of the present invention will be described in detail with reference to FIGS. 2 to 6. As described above, the mounting table structure 29 mainly includes the mounting table 32 on which the wafer W is substantially mounted and the column 30 standing upright from the bottom portion 28 to support the mounting table 32. Both the mounting table 32 and the column 30 are formed of, e.g., transparent or opaque quartz glass.

Further, as described above, the heating unit 40 having the heaters 38 is embedded in the mounting table 32. A heating region of the mounting table 32 is divided into a plurality of concentric heating zones. In this embodiment, there are provided two zones, i.e., an inner heating zone 58A and an outer heating zone 58B. The heaters 38 include an inner heater 38A and an outer heater 38B provided for the respective heating zones 58A and 58B.

Specifically, the mounting table 32 includes a mounting table main body 32A made of quartz glass and having a large thickness and a cover 32B made of quartz glass and having a small thickness, the mounting table main body 32A and the cover 32B being joined to each other by welding. Before joining, wiring grooves 60A and 60B are formed in continuous lines on the surface of the mounting table main body 32A by a cutting work in conformity with the heaters 38A and 38B in the heating zones 58A and 58B, respectively. The heaters 38A and 38B are arranged in the wiring grooves 60A and 60B, respectively. The heaters 38A and 38B are formed of, e.g., carbon wire heaters.

Further, both ends of the heater 38A are connected to interconnection wires 62X and 62Y, and both ends of the heater 38B are connected to interconnection wires 64X and 64Y. The interconnection wires 62X, 62Y, 64X and 64Y are collected in the center of the mounting table main body 32A and are extracted downward therefrom. The cover 32B is welded to the top surface of the mounting table main body 32A configured as described above. The interconnection wires 62X, 62Y, 64X and 64Y extending downward from the mounting table main body 32A are inserted in small quartz tubes 66 (see FIG. 2). Upper ends of the quartz tubes 66 are thermally bonded to a central portion of the bottom surface of the mounting table main body 32A.

Meanwhile, the column 30, which is a feature of the present invention, is made of, e.g., quartz glass that is the same material as the mounting table 32. However, the column 30 has a shape different from a conventional hollow cylindrical shape, and has a diameter gradually increasing from its lower end to its upper end. Specifically, the hollow column 30 is formed in a shape of horn aperture expanding as it goes upward. That is, an outline of the column 30 is curved outward as it goes upward in a longitudinal cross sectional view thereof. In other words, a radius of curvature of the curved outline gradually decreases from its lower end to its upper end. Further, an upper end of the column 30 is adhered to a backside (bottom surface) of the mounting table 32.

The upper end of the column 30 is thermally bonded to a peripheral portion of the inner heating zone 58A or the outer heating zone 58B. Further, an insertion passageway 68 is formed in a height direction at a portion of a sidewall of the column 30. A temperature measurement unit 70B having a rod-shaped measurement unit main body 72B is inserted in the insertion passageway 68 to pass therethrough. An element receiving hole 74B is formed at a peripheral portion of the bottom surface of the mounting table main body 32A to communicate with the insertion passageway 68. A leading end of the temperature measurement unit 70B is positioned in the element receiving hole 74B.

In this case, the element receiving hole 74B is formed at a position corresponding to the outer heating zone 58B. Accordingly, the temperature measurement unit 70B detects a temperature of the outer heating zone 58B. The temperature measurement unit 70B is formed of, e.g., a thermocouple and wires of the thermocouple are received in the measurement unit main body 72B. Accordingly, a junction of the wires of the thermocouple is positioned in the element receiving hole 74B. The measurement unit main body 72B is configured as a stainless steel pipe or an inconel pipe having therein metal wires for use in the temperature measurement junction, the metal wires being insulated with powder such as magnesium oxide or alumina. Accordingly, the measurement unit main body 72B has a certain stiffness and is bendable. Thus, the rod-shaped measurement unit main body 72B of the temperature measurement unit 70B can be inserted from the bottom into the insertion passageway 68 bent in a curved shape as described above.

A method for forming the insertion passageway 68 will be described with reference to cross sectional views (FIGS. 4, 5A to 5C) taken along line A-A of FIG. 2. First, as shown in FIG. 5A, an original form of the column 30 is fabricated of quartz glass in a shape gradually expanding as it goes upward. Then, as shown in FIG. 5B, a groove 76 is formed in a recess shape on an outer peripheral surface of a sidewall of the original form by a cutting work to extend in a height (length) direction thereof. Then, as shown in FIG. 5C, a cover 78 made of quartz glass is thermally bonded to cover the groove 76, thereby forming the insertion passageway 68. Further, the method for forming the insertion passageway 68 is not limited to the above-described method. The column 30 thus formed is thermally bonded to the bottom surface of the mounting table 32 as shown in FIG. 6.

Further, a temperature measurement unit 70A (measurement unit main body 72A) having the above-described structure is also provided at a bottom surface of a central portion of the mounting table main body 32A (i.e., the inner heating zone 58A) to detect the temperature of the inner heating zone 58A. Specifically, an element receiving hole 74A is formed on the bottom surface of the central portion of the mounting table main body 32A corresponding to the inner heating zone 58A. A leading end of the temperature measurement unit 70A is positioned in the element receiving hole 74A to detect the temperature of the inner heating zone 58A. The temperature measurement unit 70A is formed of, e.g., a thermocouple and wires of the thermocouple are received in the measurement unit main body 72A. Accordingly, a temperature measurement junction of the thermocouple is positioned in the element receiving hole 74A. The measurement unit main body 72A is configured in the same way as the measurement unit main body 72B. In this case, the measurement unit main body 72A is inserted from the bottom into the hollow column 30 in a linear manner without being bent.

Further, as shown in FIG. 2, a lower end portion of the column 30 is configured as a flange 80 having a larger diameter. The flange 80 is fixed to the bottom portion side. Specifically, an opening 82 for wiring is formed at a central portion of the bottom portion 28. A ring-shaped base plate 84 made of, e.g., an aluminum alloy is fastened and fixed, via bolts 86, to a peripheral portion of the opening 82 on the inside of the processing chamber 4. In this case, a seal member 88 such as an O ring is interposed between the base plate 84 and the opening 82 to ensure airtightness.

Further, the flange 80 of the lower end portion of the column 30 is installed on the ring-shaped base plate 84 via a seal member 90 such as an O ring. A ring-shaped pressing member 92, which is made of, e.g., an aluminum alloy and has an L-shaped cross section, is mounted on a peripheral portion of the flange 80. The pressing member 92 is fastened to the base plate 84 via bolts 94, thereby fixing the flange 80. Accordingly, the column 30 is fixed in an upstanding state.

Further, an auxiliary plate 96 and an insulating auxiliary plate 98 are detachably installed on the bottom surface of the base plate 84, respectively. The auxiliary plate 96 supports the rod-shaped measurement unit main bodies 72A and 72B passing therethrough. The insulating auxiliary plate 98 is made of an insulating material and supports the interconnection wires 62X, 62Y, 64X and 64Y passing therethrough. Further, the interconnection wires 62X, 62Y, 64X and 64Y are connected to heater power supplies (not shown), respectively.

Referring back to FIG. 1, interconnection lines 100A and 100B from the measurement unit main bodies 72A and 72B are inputted to a temperature controller 102, respectively. An apparatus controller 104 having, e.g., a computer individually controls powers inputted the heaters 38A and 38B corresponding to the heating zones 58A and 58B based on the instructions of the temperature controller 102, thereby performing temperature control. The apparatus controller 104 controls an a process pressure, a gas flow rate and the like in addition to the temperatures of the heating zones 58A and 58B, i.e., an entire operation of the apparatus, based on a predetermined program.

Hereinafter, an operation of the heat treatment apparatus having the above-described configuration will be described.

First, an unprocessed semiconductor wafer W is held on a transfer arm (not shown) and is loaded into the processing chamber 4 through the gate valve 18 (gate 16) in an open state. The wafer W is delivered to the upthrust pins 46 in a raised state. The wafer W is mounted on the top surface of the mounting table 32, particularly, the top surface of the top covering member 42, by moving the upthrust pins 46 down.

Then, film forming gases A and B with flow rates controlled are supplied as processing gases to the shower head 6. The gases A and B are introduced into the processing space S through the gas injection holes 10A and 10B. Although not shown in the drawings, the vacuum pump provided in the gas exhaust pipe 36 is operated to vacuum evacuate the inner space of the processing chamber 4 and the gas exhaust space 22. Further, the processing space S is maintained at a predetermined pressure by adjusting a valve opening degree of the pressure control valve. The wafer W is maintained to have a specific process temperature. Accordingly, a thin film is formed on the surface of the semiconductor wafer W.

During the heat treatment (film forming process), the temperature of the wafer W is controlled by the heating unit 40 embedded in the mounting table 32. In this case, while the wafer W is maintained to have a specific process temperature as described above, the temperatures of the inner heating zone 58A and the outer heating zone 58B of the mounting table 32 are detected by the temperature measurement units 70A and 70B formed of, e.g., thermocouples corresponding to the respective heating zones 58A and 58B. The detection results are sent to the temperature controller 102.

Further, the temperature controller 102 individually controls, via the apparatus controller 104, powers inputted the heaters 38A and 38B corresponding to the heating zones 58A and 58B based on the detection results. As described above, the temperatures of the respective heating zones are directly detected and the powers inputted the respective heaters are individually controlled based on the detection values. Therefore, it is possible to maintain higher in-plane temperature uniformity of the wafer W compared with a conventional apparatus in which power inputted to the outer heating zone is indirectly determined based on a predetermined power ratio.

In particular, as the number of processed wafers increases, the emissivity toward the wafer W in the processing chamber 4 is varied due to adhesion of unnecessary films. Even in this case, by detecting the temperatures of the respective heating zones 58A and 58B, it is possible to maintain higher in-plane temperature uniformity of the wafer W without being influenced by variation of the emissivity. Accordingly, it is possible to improve reproducibility of the heat treatment, e.g., a film forming process, on the wafer W.

Further, when it is necessary to change the temperature measurement units 70A and 70B formed of, e.g., thermocouples due to aging, the auxiliary plate 96 (see FIG. 2) provided below the column 30 of the mounting table structure 29 is detached from the base plate 84. Then, the rod-shaped measurement unit main body 72A of the temperature measurement unit 70A provided at the inner heating zone 58A or the rod-shaped measurement unit main body 72B of the temperature measurement unit 70B provided at the outer heating zone 58B is extracted downward and detached from the column 30. Thereafter, a new one is inserted and attached to the column 30.

In this case, a new rod-shaped measurement unit main body 72A to be positioned in the center of the column 30 can be easily attached to the column 30 by simply inserting the measurement unit main body 72A into the column 30 linearly upward.

Further, a new rod-shaped measurement unit main body 72B corresponding the outer heating zone 58B is preferably guided along the insertion passageway 68 formed at the sidewall of the column 30 by inserting the measurement unit main body 72B into the insertion passageway 68 of the column from the bottom. Accordingly, a leading end of the measurement unit main body 72B can be easily inserted and positioned in the element receiving hole 74B.

The rod-shaped measurement unit main body 72B is formed of, e.g., a metal pipe, but is elastically bendable to some extent. Accordingly, the measurement unit main body 72B can be smoothly inserted into the insertion passageway 68 by being deformed along the curved insertion passageway 68. If a radius of curvature of the curve formed along the insertion passageway 68, i.e., the curve created by an outer frame of the column 30 from the bottom to the top, becomes excessively small, a deformation amount corresponding to the radius of curvature exceeds an allowable deformation amount of the measurement unit main body 72B, and the measurement unit main body 72B cannot be inserted into or detached from the insertion passageway 68. Thus, a minimum allowable value of the radius of curvature of the curve should be determined based on, e.g., stiffness of the measurement unit main body 72B, stiffness of the column 30 made of quartz glass and the like. Specifically, the minimum allowable value of the radius of curvature is about 20 mm, and in this case, the radius of curvature of the curve is set to be 50 mm.

As described above, in accordance with the embodiment of the present invention, the hollow column 30 supporting the mounting table 32 is formed to have a diameter gradually increasing from the bottom to the top, and the measurement unit main body 72B of the temperature measurement unit 70B is inserted into the column 30 to pass therethrough. Accordingly, it is possible to provide respective temperature measurement units corresponding to a plurality of heating zones without a complicated structure. Therefore, it is possible to maintain higher in-plane temperature uniformity of the wafer W serving as an object to be treated, and to improve reproducibility of the heat treatment.

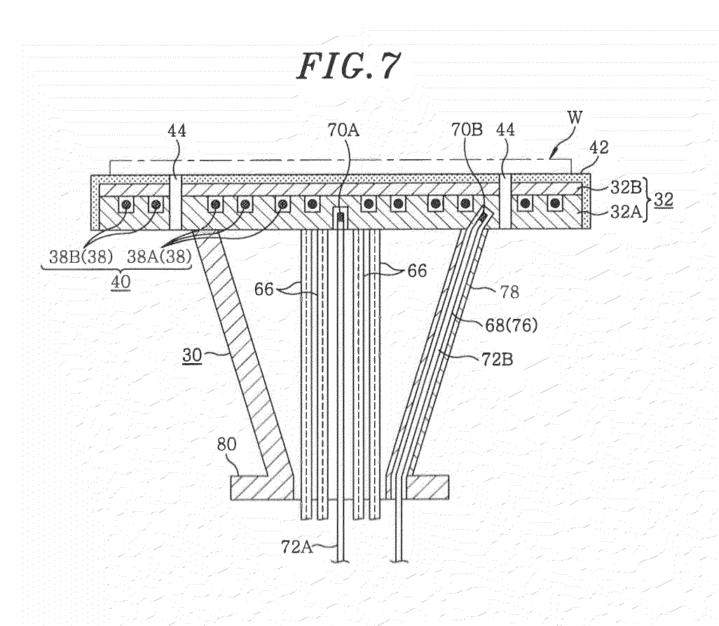

Further, although the outer frame of the column 30 was formed in a curved shape in its cross sectional view in the above embodiment, the present invention is not limited thereto. As in a modification example of the mounting table structure shown in FIG. 7, the outer frame of the column may be formed in an oblique linear shape (tapered shape). In this case, the column 30 is formed in an inverted truncated cone shape, and the insertion passageway 68 is formed in an almost linear shape. Accordingly, the rod-shaped measurement unit main body 72B can be relatively easily inserted into and detached from the column 30.

Further, the column 30 may be formed in a trumpet-shaped opening including a cylindrical lower portion and an upper portion expanding as it goes upward as shown in FIG. 2.

Further, although the mounting table 32 and the column 30 were formed of quartz glass in the above embodiment, the mounting table 32 and the column 30 may be formed of an aluminum alloy, stainless steel, a ceramic material such as SiC and Al₂O₃ or the like without being limited thereto. Furthermore, in consideration of thermal expansion, it is preferable that the mounting table 32 and the column 30 are formed of the same material.

Further, although the heating region of the mounting table 32 was divided into two concentric heating zones in the above embodiment, the present invention may be applied to three or more heating zones without being limited thereto.

Further, although thermocouples were used as the temperature measurement units 70A and 70B in the above embodiment, the temperature measurement unit that detects infrared radiant energy from the heating zones 58A and 58B by using a photovoltaic element such as InGaAs, which is known as an optical fiber radiation thermometer, can be used without being limited thereto. In the optical fiber radiation thermometer, a rod-shaped bendable optical fiber may be used as an infrared transmission path (guide path) to the photovoltaic element. A leading end of the optical fiber is positioned in the element receiving hole 74A or 74B. That is, the measurement unit main body 72A or 72B corresponds to the optical fiber.

Further, although a film forming process was performed as the heat treatment in the above embodiment, the present invention may be applied to all heat treatments such as an annealing process, a modification process, and an oxidation/diffusion process to heat the wafer without being limited thereto.

Further, although the semiconductor wafer was used as an object to be treated in the above embodiment, the present invention may be applied to a glass substrate, an LCD substrate, a ceramic substrate and the like without being limited thereto.

While the invention has been shown and described with respect to the embodiments, it will be understood by those skilled in the art that various changes and modification may be made without departing from the scope of the invention as defined in the following claims.

What is claimed is:

1. A mounting table structure comprising:
a mounting table on which an object to be heat-treated is mounted, the mounting table including a heating unit having heaters respectively disposed in concentric heating zones;
temperature measurement units respectively disposed in the heating zones; and
a hollow column for supporting the mounting table in an upstanding state,
wherein a diameter of the column gradually increases from its bottom to its top,
an upper end of the column is bonded to a bottom surface of the mounting table, and
a measurement unit main body of each of the temperature measurement units is inserted into an insertion passageway provided inside the hollow column and at a sidewall of the column.

2. The mounting table structure of claim 1, wherein the measurement unit main body is formed in a bendable rod shape.

3. The mounting table structure of claim 1, wherein the temperature measurement units are formed of thermocouples, respectively.

4. The mounting table structure of claim 1, wherein the mounting table and the column are formed of the same constituent material.

5. The mounting table structure of claim 4, wherein the constituent material is one selected from the group consisting of metal, quartz and ceramic.

6. The mounting table structure of claim 1, wherein the column is formed in a shape of horn aperture expanding from its bottom to its top.

7. The mounting table structure of claim 6, wherein a minimum value of a radius of curvature of an outline of the column in its cross sectional view is determined based on at least stiffness of the measurement unit main body.

8. The mounting table structure of claim 7, wherein the minimum value of the radius of curvature is 20 mm.

9. The mounting table structure of claim 1, wherein the column is formed in a tapered shape expanding from its bottom to its top.

10. The mounting table structure of claim 1, wherein the measurement unit main body can be inserted into the column from its bottom and detached therefrom.

11. A heat treatment apparatus comprising:
a vacuum evacuable processing chamber;
a mounting table structure described in claim 1;
a gas supply unit for supplying a gas into the processing chamber; and
a temperature controller for controlling a temperature of the mounting table of the mounting table structure.
